(19) United States
(12) Patent Application Publication
(10) Pub. No.: US 2010/0014749 A1
(43) Pub. Date: Jan. 21, 2010

(54) METHOD AND DEVICE FOR ADJUSTING THE DEPOSIT POSITION OF A SEMICONDUCTOR WAFER IN AN OVEN

(75) Inventor: Sebastien Turlure, Saint Zacharie (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS SAS, Rousset (FR)

(21) Appl. No.: 12/504,361

(22) Filed: Jul. 16, 2009

(30) Foreign Application Priority Data
Jul. 17, 2008 (FR) 08 04063

(51) Int. Cl. G06K 9/00; G01B 11/26; G08B 17/00

(52) U.S. Cl. 382/151; 356/399; 340/584; 901/14

(57) ABSTRACT

A method for loading a semiconductor wafer into a process unit comprises opening the process unit, inserting a wafer into the process unit, adjusting the position of the wafer in the process unit so that it is in a certain position in relation to markers, and inserting a camera into the process unit facing the markers. The camera acquires an image of the markers and of a part of the wafer, and displays on a display screen the image acquired. The position of the wafer is adjusted according to the position of the wafer in relation to the markers on the image displayed.

### BACKGROUND

1. Technical Field

The present disclosure relates to the manufacture of integrated circuits on a semiconductor wafer and more particularly loading a semiconductor wafer into an oven.

2. Description of the Related Art

The ovens used for the manufacture of integrated circuits, and particularly to bake the layers of photo-sensitive resin, comprise several oven units, each comprising a process chamber provided to receive a semiconductor wafer to be processed. The chamber is closed by a cover movable between a high position in which the chamber is open for loading and unloading a wafer, and a low position for closing the chamber. The chamber comprises retractable pins for supporting a wafer, distributed on the periphery thereof and allowing the wafer to be moved between a high loading position and a low processing position. Loading and unloading a wafer in the oven is performed using a robotic arm which allows in particular a wafer to be introduced into the processing chamber at a very precise position. The wafers are positioned in the oven units in a clearly determined position so as to ensure that the wafer is subjected to a strictly homogeneous temperature rise in the oven unit. To that end, the robotic arm has three positions by oven unit, i.e., a high position to introduce a wafer into the oven unit, a median position to adjust the position of the wafer in the oven unit, and a low position in which it may go out of the oven without the wafer which is then supported by the pins.

A learning phase is therefore provided to allow the control system of the robotic arm to memorize the exact position where the wafers are deposited in each oven unit. This learning phase is performed each time the arm looses a positioning marker or a wafer positioning defect is detected in an oven unit. The learning phase causes the manufacturing line to stop and includes the intervention of an operator who controls the move of the arm using a control panel to adjust the position of a wafer in an oven unit, until the wafer reaches the desired position. The operator then controls the memorization by the control system of the position of the arm for the oven unit where the wafer is located. The learning phase thus comprises memorizing the deposit position of a wafer in each oven unit.

For wafer heat homogeneity and dimensions reasons, the process chamber of oven units used in the manufacture of integrated circuits has lower and lower dimensions to substantially reach the volume of the wafers to be processed. The result is that the slightest positioning defect of a wafer in an oven unit may cause the breakage of the wafer, particularly when closing the oven unit, and therefore the break of the manufacturing line for a relatively long duration to remove the pieces of broken wafer from the oven unit. For dimensions reasons too, the travel of the cover is very reduced, so that it is hard for an operator to see if the wafer is properly positioned inside the oven.

One type of machine is a DNS SK-2000 commercialized by the company DAI NIPPON SCREEN. A machine of this type comprises 36 oven units located at a height of 2.20 m on average. Determining the deposit position of the wafers in oven units employs a scaffolding of a height around 1.30 m, on which the operator climbs to observe the position of the wafer in each oven unit, and handle the robotic arm by means of the control panel. Adjusting the position of a wafer in a unit takes around 10 to 15 minutes, i.e., 6 to 9 hours for the whole learning phase allowing the control system of the robotic arm to be set for all the units of a machine. This duration is considerably increased if a wafer is not positioned properly and breaks when closing the oven unit.

To reduce the duration of the learning phase, it has been considered to use the positions of the oven units relative to each other to determine the deposit position of a wafer in each oven unit from a deposit position manually determined by an operator for an oven unit. It has proven that this solution is not reliable and leads to numerous wafer positioning errors in oven units.

It is therefore desirable to reduce the duration of the learning phase and therefore make it easier to adjust the deposit position of a semiconductor wafer in an oven unit and be able to ensure that the wafer is properly positioned before closing the oven.

In an embodiment, a method is provided for loading a semiconductor wafer into a process unit, comprising opening the process unit, inserting a wafer into the process unit, and adjusting the position of the wafer in the process unit so that it is in a certain position in relation to markers. According to one embodiment, the method comprises inserting a camera into the process unit facing the markers, the camera acquiring an image of the markers and of a part of the wafer, and displaying the image acquired on a display screen, adjusting the position of the wafer being performed according to the position of the wafer in relation to the markers on the image displayed.

According to one embodiment, the markers are retractable pins supporting the edge of the wafer when the process unit is in open configuration.

According to one embodiment, an image of each marker is acquired by a respective camera, the images acquired of all the markers being simultaneously displayed.

According to one embodiment, the method comprises taking apart a part of a cover of the process unit and fixing as a replacement for the cover part, an acquisition module comprising the camera.

According to one embodiment, the markers are enlightened during acquisition.

According to one embodiment, the process unit is an oven unit.

According to one embodiment, the method comprises monitoring the temperature in the oven unit during acquisition, and generating an alarm signal if the temperature measured exceeds a threshold value.

According to one embodiment, the process unit is an oven unit belonging to a machine of DNS SK2000 type.

In an embodiment, a learning method is also provided for the control of a robotic arm for loading and unloading semiconductor wafers in a machine comprising several wafer processing units, the method comprising, for each process unit, loading a wafer into the process unit by means of the robotic arm, adjusting the position of the wafer in the process unit by means of the robotic arm, and memorizing the position of the robotic arm for the process unit when the wafer has reached a desired position. According to one embodiment, loading and positioning the wafer in each process unit is performed in accordance with the method previously defined.

In an embodiment, a device is also provided for helping positioning a semiconductor wafer into a process unit, configured to be introduced into a process unit, and comprising a camera configured to acquire an image of markers in relation to which the position of a semiconductor wafer is to be adjusted, and an image processing circuit for generating images which can be visualized on a display screen.

According to one embodiment, the device comprises as many cameras as markers to be visualized in the process unit to perform the setting of the position of the wafer in the process unit.

According to one embodiment, the image processing circuit is configured to simultaneously display the images acquired by all the cameras.

According to one embodiment, the device is configured to be fixed to the process unit as a replacement for a cover part of the process unit.

According to one embodiment, the device comprises one or two elements for lighting markers for each camera.

According to one embodiment, the device comprises a circuit for monitoring the temperature in the oven unit, configured to generate an alarm signal if the temperature measured exceeds a threshold value.

According to one embodiment, the device is configured to be mounted onto a cover part of a process unit.

According to one embodiment, the process unit is an oven unit of a machine of DNS SK2000 type.

### BRIEF DESCRIPTION OF THE SEVERAL VIEWS OF THE DRAWINGS

Some embodiments will be described hereinafter in relation with, but not limited to the appended figures wherein:

FIG. 1 schematically shows in cross-section an oven unit in open configuration with a semiconductor wafer being inserted into the oven,

FIG. 2 shows in top view a wafer on a support plate of oven unit,

FIG. 3 schematically shows in cross-section an oven unit in closed configuration, with a semiconductor wafer inside,

FIG. 4 schematically shows a device for helping setting the deposit position of a wafer in an oven unit, according to one embodiment,

FIG. 5 is a schematic side view of an acquisition module of the setting helping device shown in FIG. 4,

FIG. 6 schematically shows in front view the acquisition module shown in FIG. 5,

FIG. 7 schematically shows in cross-section an oven unit equipped with the acquisition module,

FIG. 8 shows a visualization screen displaying images supplied by the acquisition module.

### DETAILED DESCRIPTION

FIG. 1 shows an oven unit 10 in an open configuration, for example of a machine of DNS SK-2000 type. The oven unit 10 comprises a lower part 11a, a cover 11b and a frame 15 fixed to the cover and forming lateral partitions of the oven unit. The lower part 11a of the oven unit houses a plate 12 to support a semiconductor wafer, and pins 13a to 13f perpendicular to the plate 12, crossing the plate and having a higher face spreading out above the plate. FIG. 1 also shows a semiconductor wafer 1 maintained by a robotic arm 19, being inserted into the oven unit 10.

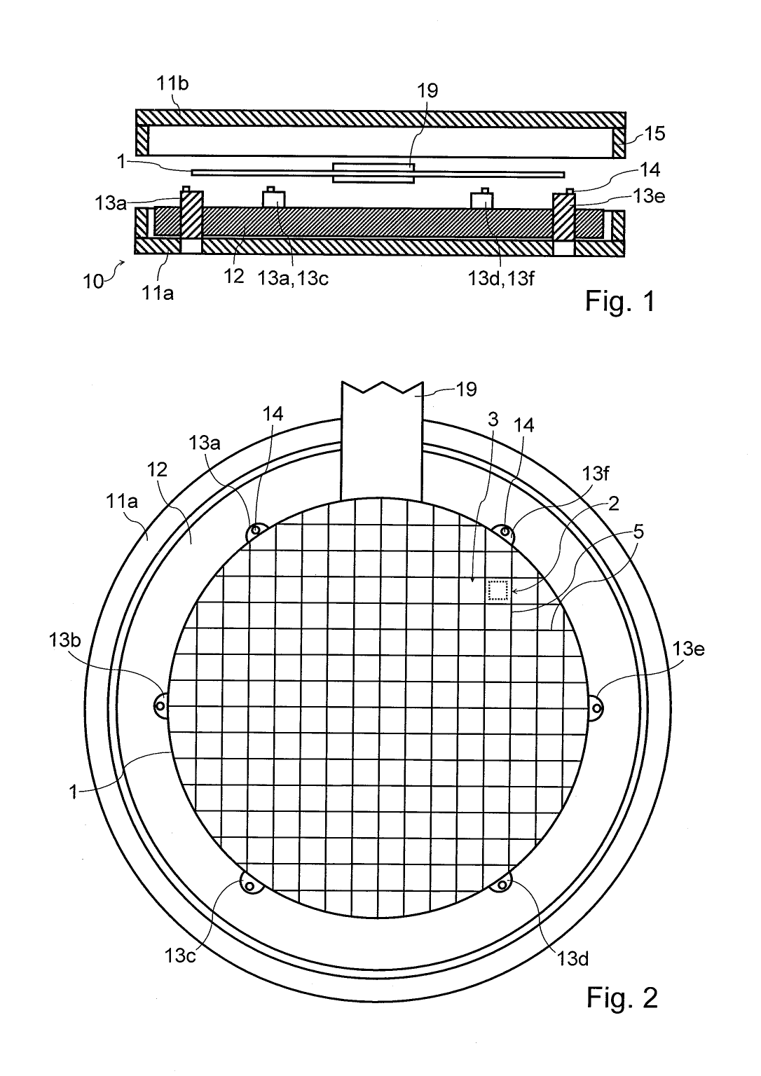

FIG. 2 shows the plate 12 of circular shape and a semiconductor wafer 1 maintained above the plate by the pins 13a-13f. In FIG. 2, the pins 13a-13f are distributed in the oven unit so as to be able to support the wafer 1 by its periphery and to maintain it substantially parallel and centered above the plate 12. To that end, each pin 13a-13f comprises a lug 14 formed on the higher face of the pin to prevent the wafer from laterally sliding and maintain it in a position substantially centered above the plate 12. The pins allow the robotic arm 19 to maintain the wafer from below, to deposit it into the oven and to be removed from the oven after depositing the wafer onto the pins.

The wafer conventionally has a circular shape, with scribe lines 5 allowing the chips 2 of substantially rectangular shape, on each of which an integrated circuit 3 may be formed, to be separated.

In the example of FIG. 2, there are six pins 13a-13f which are positioned so as to be evenly distributed around a wafer 1 when the latter is centered in the oven unit 10.

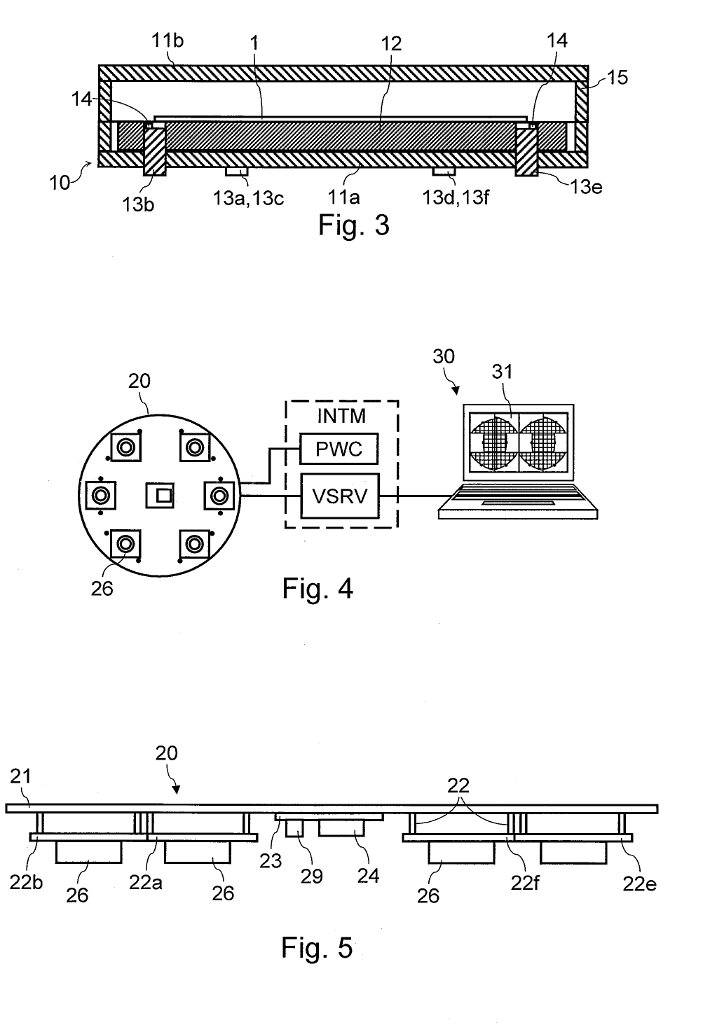

FIG. 3 shows the oven unit 10 in closed configuration, the lower edge of the frame 15 being applied against the edge of the lower part 11a of the oven unit. During the closing of the oven unit, the pins 13a-13f completely retract into the plate 12 so that the wafer 1 is only supported by the plate 12.

The wafer may be deposited onto the pins 13a-13f, precisely between the lugs 14, in particular, to ensure a uniform temperature distribution during the process of the wafer 1 in the oven unit 10. The accurate positioning of the wafer in the oven unit is also desirable due to the diameter of the pins which is relatively low to avoid the pins from affecting the uniformity of temperature distribution on the wafer during the process thereof. Indeed, if the wafer is not centered above the plate 12, it may fall between the pins 13a-13f when the robotic arm 19 deposits it onto the pins and is removed from the oven unit.

FIG. 4 schematically shows a device for helping setting the deposit position of a wafer in an oven unit, according to one embodiment. The setting helping device comprises an acquisition module 20 for acquiring the position of the wafer 1 in relation to each pin 13a-13f, and an interface module INTM. The module INTM is configured to connect the acquisition module 20 to a computer 30 and supply to the acquisition module 20 the supply voltages for operating the acquisition module. The acquisition module 20 comprises one or more cameras 26 to acquire an image showing each pin and the position of the edge of the wafer 1 in relation to the pin. The interface module INTM comprises a power supply circuit PWC powering the module 20 and a video server VSRV connected to the cameras 26 and generating from the signals supplied by the cameras 26 images which can be used by the computer 30. The images generated by the server VSRV are transmitted to the computer 30. The computer 30, for example of portable type, has a software adapted to the process and display of the images supplied by the server VSRV, and a screen 31 to display them.

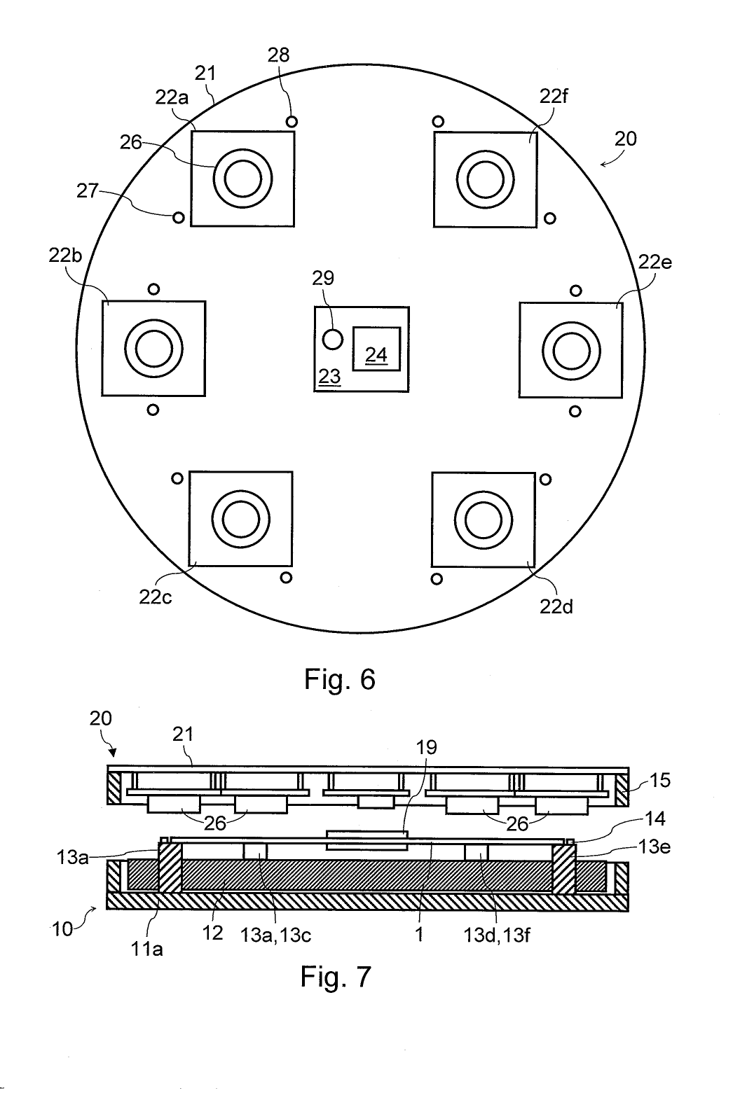

FIGS. 5 to 6 show the acquisition module 20. The acquisition module 20 comprises a printed circuit board 21 on which the camera modules 22a-22f, each comprising a camera 26, are mounted. Each module 22a-22f is associated to a lighting device comprising for example two light-emitting diodes 27, 28 (FIG. 6) arranged on each side of the objective of the camera module. The diodes 27, 28 supply for example white light.

The number of camera modules 22a-22f may be provided equal to the number of pins 13a-13f of the oven unit. Thus, in the example of FIGS. 2 and 6, the acquisition module 20 comprises six camera modules 22a-22f, each comprising a camera 26, distributed on the board 21 so as to be able to supply images of each pin 13a-13f.

The acquisition module 20 may also comprise a module for monitoring the temperature comprising a temperature sensor 29 and an audio signal transmitter 24, and a circuit for processing the signal supplied by the sensor 29 to trigger the transmission of an audio signal if the temperature measured by the sensor exceeds a certain threshold value. The whole consisting of the sensor 29, the transmitter 24 and the processing circuit is for example mounted on a board 23. Thus, if the acquisition module 20 is placed in a too hot oven that may damage the cameras 26 in particular, an audio signal is emitted. It may also be provided to send an alarm signal to the interface module INTM which may then emit an audio signal if the temperature measured by the sensor 29 exceeds the threshold value.

FIG. 7 shows an oven unit 10 in open configuration, a wafer 1 being maintained on the pins 13a-13f by the robotic arm 19. The acquisition module 20 is associated to the oven unit 10, by being fixed to the frame 15 previously separated from the cover 11b. To that end, the board 21 has a shape and dimensions adapted to those of the frame 15, the camera modules 22a-22f being fit into the frame 15 and positioned so that each may supply an image of a pin 13a-13f.

In an embodiment, the cameras 26 of the modules 22a-22f are cameras with fixed focal distance and without focusing setting. The modules 22a-22f are then mounted above the board 21 using spacers 22 which height is adjusted so that the images of the pins 13a-13f supplied by the cameras are clear.

In another embodiment, the cameras 26 of the modules 22a-22f are of autofocus type, and adjust the clearness of the image so that the higher surface of each pin 13a-13f is clear in the images supplied. In this case, the spacers 22 may not be required.

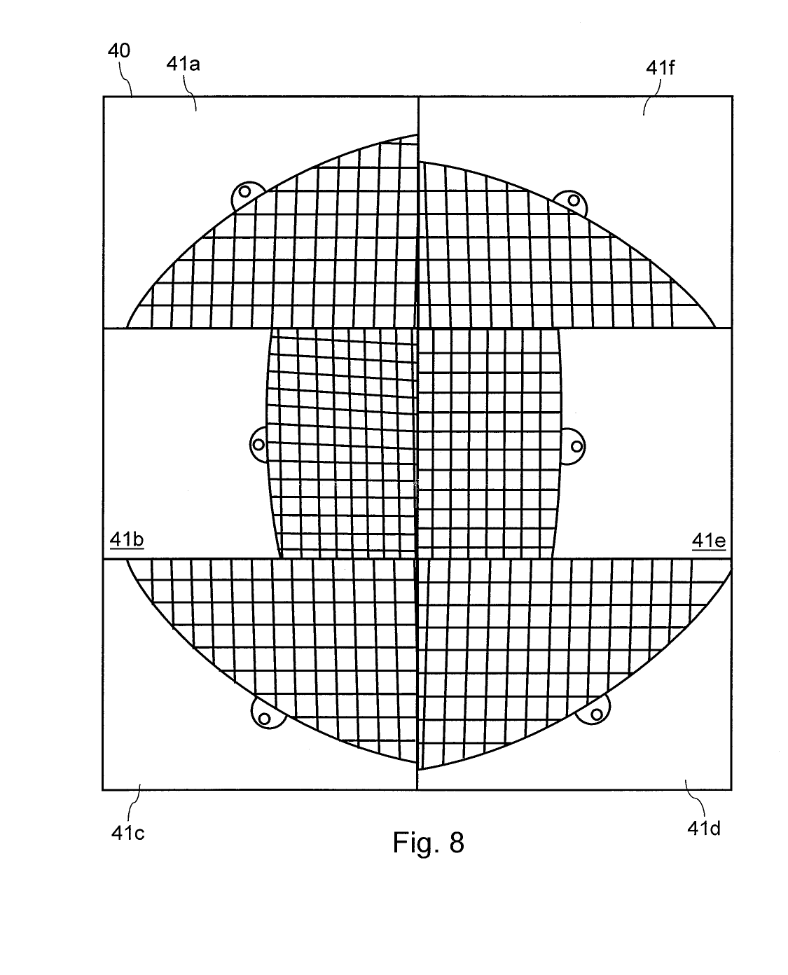

FIG. 8 shows a composite image 40 displayed by the computer 30. The composite image 40 comprises an image of a pin 41a-41f supplied by each camera module 22a-22f. Each image of pin 41a-41f shows the edge of the wafer 1, one of the pins 13a-13f and the lug 14 formed on the pin. The operator may thus visualize the precise position of the edge of the wafer 1 in relation to each pin 13a-13f and particularly in relation to the lug 14 of each pin, and control the robotic arm 19 so as to position the wafer 1 in a precise position in relation to each pin, so that the edge of the wafer is at a same distance from each lug 14. To that end, the image processing software installed in the computer 30 may be configured to allow one or more images of pins 41a-41f previously selected by the operator to be magnified. When the wafer 1 is properly positioned in relation to the pins 13a-13f, the operator can control the memorization of the position of the robotic arm 19.

The cameras 26 may be equipped with a zoom controlled by the image processing software, so as to be able to adjust the size of the portion of image 41a-41f of each pin.

It will be clear to those skilled in the art that the present disclosure is susceptible of various other embodiments and applications. In particular, the disclosure does not only apply to ovens, or to a particular type of oven unit, or to an oven unit comprising a particular number of pins, but to any process unit wherein it is desirable for the wafer to be precisely positioned. In addition, other markers than pins may be used to evaluate the position of the wafer in the oven unit.

It is not required either that the number of camera modules corresponds to the number of pins. It may thus be provided that each camera module supplies an image of several pins. If the dimensions of the oven unit make it possible, the acquisition module may comprise only one camera module supplying a complete image of the wafer 1 and therefore of the pins distributed at the periphery of the wafer.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for loading a semiconductor wafer into a process unit, comprising:
opening the process unit;
inserting the wafer into the process unit near a plurality of markers in the process unit;
acquiring at least one image of at least one marker and of at least a part of the wafer;
displaying the at least one image on a display screen; and
adjusting a position of the wafer relative to the markers according to the at least one image displayed until the wafer is in a desired wafer position relative to the markers.

2. The method according to claim 1, wherein the markers are retractable pins supporting an edge of the wafer when the process unit is in an open configuration.

3. The method according to claim 1, wherein the acquiring includes acquiring a plurality of images of the markers, respectively, using a plurality of cameras, respectively, and the displaying includes simultaneously displaying the plurality of images.

4. The method according to claim 1, wherein the camera is part of an acquisition module installed as a cover part of the process unit.

5. The method according to claim 1, wherein the markers are illuminated during acquisition.

6. The method according to claim 1, wherein the process unit is an oven unit.

7. The method according to claim 6, comprising monitoring a temperature in the oven unit during the acquiring, and generating an alarm signal if the temperature exceeds a threshold value.

8. The method according to claim 6, wherein the oven unit belongs to a DNS SK2000 machine.

9. The method of claim 1 wherein the adjusting includes adjusting the position of the wafer by a robotic arm, the robotic arm being in a desired robotic arm position when the wafer reaches the desired wafer position, the method further comprising:
recording the desired robotic arm position.

10. The method of claim 9 wherein the process unit is one of a plurality of process units, the method comprising recording desired robotic arm positions for each process unit respectively.

11. A device for helping to position a semiconductor wafer into a process unit, the device comprising:
a camera configured to acquire an image of a position of a semiconductor wafer in relation to a marker in the semiconductor process unit; and
an image processing circuit coupled to the camera and configured to process the image for display.

12. The device according to claim 11, wherein the camera is one of a plurality of cameras of the device, the cameras being coupled to the image processing unit and configured to generate a plurality of images, respectively, of the position of the semiconductor wafer with a plurality of markers, respectively.

13. The device according to claim 12, wherein the image processing circuit is configured to enable simultaneous display of the images acquired by the cameras.

14. The device according to claim 11, wherein the device is configured to be fixed to a cover part of the process unit.

15. The device according to claim 12, comprising a plurality of lighting elements for illuminating the markers.

16. The device according to claim 11, comprising a temperature monitor circuit for monitoring a temperature in the process unit, the temperature monitor circuit being configured to generate an alarm signal if the temperature measured exceeds a threshold value.

17. A method comprising:
inserting a semiconductor wafer into a process unit of a process device, the process unit comprising a plurality of position markers;
acquiring a first image of a position of the semiconductor wafer in relation to a position marker with an image capturing system;
displaying the image on a display; and
adjusting the position of the semiconductor wafer according to the image.

18. The method of claim 17 wherein the image capture system is a camera.

19. The method of claim 17 wherein the image capture system is a plurality of cameras, each camera acquiring a respective second image of a respective position marker.

20. The method of claim 19 wherein the first image comprises the second images spliced together.

21. The method of claim 18 wherein the position of the wafer is adjusted by a robotic arm.

22. The method of claim 21 comprising:
adjusting the position of the wafer until the wafer has reached a desired wafer position, a desired robotic arm position being reached when the wafer reaches the desired wafer position; and
recording the desired robotic arm position.

23. The method of claim 22 wherein the process device comprises a plurality of process units, the method comprising recording a plurality of separate desired robotic arm positions for the process units respectively.

24. A system comprising:
a semiconductor processing unit having a plurality of wafer position markers;
an image acquisition module coupled to the semiconductor processing unit and configured to acquire a first image of a position of a semiconductor wafer in relation to at least one of the position markers;
a display screen coupled to the image acquisition module and configured to display the image; and
a robotic arm coupled to the semiconductor processing unit and configured to adjust the position of the wafer according to the image.

25. The system of claim 24 comprising a computer configured to record a desired robotic arm position, the desired robotic arm position being defined as an orientation of the robotic arm at a time when the wafer reaches a desired wafer position.

26. The system of claim 24 wherein the image acquisition module comprises a plurality of cameras configured to take a plurality of respective second images of the wafer.

27. The system of claim 26 wherein the first image comprises the second images spliced together.

28. The system of claim 24 comprising a light configured to illuminate the markers.
